(19) United States
(12) Patent Application Publication
(10) Pub. No.: US 2014/0304403 A1
(43) Pub. Date: Oct. 9, 2014

(54) VALIDATION OF A COMMUNICATION NETWORK OF AN INDUSTRIAL AUTOMATION AND CONTROL SYSTEM

(71) Applicant: ABB RESEARCH LTD, Zurich (CH)

(72) Inventors: Hadeli HADELI, Baden (CH); Thanikesavan SIVANTHI, Birmenstorf (CH); Otmar GOERLITZ, Fislisbach (CH); Wolfgang WIMMER, Rietheim (CH)

(73) Assignee: ABB RESEARCH LTD,, Zurich (CH)

(21) Appl. No.: 14/309,093

(22) Filed: Jun. 19, 2014

Related U.S. Application Data
(63) Continuation of application No. PCT/EP2012/076268, filed on Dec. 20, 2012.

(30) Foreign Application Priority Data
Dec. 20, 2011 (EP) 11194437.7

(51) Int. Cl. H04L 12/26

(52) U.S. Cl. CPC H04L 43/08
USPC 709/224

(57) ABSTRACT

A unit is disclosed for validating a communication network of an industrial automation and control system. The validation unit can include a planner module configured to store plan data defining a designed communication network of an industrial automation and control system, and a collector module configured to collect effective data defining a deployed communication network of the industrial automation and control system. A difference detector can detect differences between the designed communication network and the deployed communication network using the plan data and the effective data such that faults or errors in a deployed communication network of the industrial automation and control system can be efficiently detected.

### RELATED APPLICATIONS

This application claims priority as a continuation application under 35 U.S.C. §120 to PCT/EP2012/076268, which was filed as an International Application on Dec. 20, 2012 designating the U.S., and which claims priority to European Application 11194437.7 filed in Europe on Dec. 20, 2011. The entire contents of these applications are hereby incorporated by reference in their entireties.

### FIELD

The present disclosure relates to a unit for validating a communication network of an industrial automation and control system and to a method of validating a communication network of an industrial automation and control system.

### BACKGROUND INFORMATION

Industrial automation and control systems are used to control industrial plants (e.g., for manufacturing goods, generating power, processing substances, producing electric power, etc). Ethernet has become widely used as a communication technology in industrial automation and control systems. However, the use of Ethernet presents new challenges to commissioning engineers, such as to make sure that the network is performing as expected. When only analogue communication technologies were involved, network connections could be easily verified using a multi-meter. In present communication technologies, such as Ethernet, when nodes or network controls (e.g., e.g. network switches) are not correctly configured, diagnosing the problem can be a difficult, time consuming, and cumbersome task, as current engineering tools do not provide automatic validation and troubleshooting of Ethernet configurations. Consequently, the commissioning process of such industrial automation and control systems may be time consuming and expensive.

After receipt of the order of a customer, an engineering team for designing industrial automation and control systems may design the requested system and produce, for example, a system description file. In case of electrical substation automation systems, for example, a system description file according to the IEC 61850 standard may be produced, which is the SCD file (SCD: Substation Configuration Description) that contains the information on the entities in the substation automation system as well as on the logical data flow in the substation automation system. In general process automation systems or industrial automation and control systems, the system description file may be the system planner file.

On the basis of the system description file, the commissioning engineers deploy the industrial automation and control system. One particular aspect is to deploy the physical communication network of the industrial automation and control system, which implies, among others, the installation of network cables, network controls, and end nodes in order to form the commissioned network architecture.

In current practice, no validation process whatsoever is made to automatically validate the commissioned network architecture. No state-of-the art solution exists in the realm of industrial automation and control systems which automatically validates the commissioned network. Hence, there is currently no automated solution to test whether the commissioned network is correctly deployed or whether the network contains errors, and as a consequence, in case of a wrongly deployed network, errors may be noticed only during testing or operation of the industrial automation and control system, which may give rise to significant production delays, downtimes or even security risks.

### SUMMARY

A unit for validating a communication network of an industrial automation and control system is disclosed, comprising: a planner module configured to store plan data defining a designed communication network of an industrial automation and control system; a collector module configured to collect effective data defining a deployed communication network of the industrial automation and control system; and a difference detector configured to detect differences between the designed communication network and the deployed communication network using the plan data and the effective data.

A method of validating a communication network of an industrial automation and control system is also disclosed, comprising: storing plan data defining a designed communication network of an industrial automation and control system; collecting effective data defining a deployed communication network of the industrial automation and control system; and detecting differences between the designed communication network and the deployed communication network using the plan data and the effective data.

A computer program product is also disclosed comprising a non-transitory computer-readable medium having stored thereon computer program code which will, upon execution, direct a processor of a computer to: store plan data of a designed communication network of an industrial automation and control system; collect effective data of a deployed communication network of the industrial automation and control system; and detect differences between the designed communication network and the deployed communication network using the plan data and the effective data.

### BRIEF DESCRIPTION OF THE DRAWINGS

Features disclosed herein will be explained in more detail, by way of exemplary embodiments, with reference to the drawings in which:

FIG. 1 shows an exemplary validation unit according to the present disclosure;

FIG. 2 shows an exemplary substation automation system requested by a customer;

FIG. 3 shows schematically an exemplary substation automation system which has been designed by an engineering team for designing industrial automation and controls systems;

FIG. 4 shows schematically a physical view of an exemplary network for a substation automation system which has been deployed by commissioning engineers;

FIG. 5 shows schematically an exemplary logical view of the network according to FIG. 4; and

FIG. 6 shows schematically exemplary steps for validating a communication network according to the present disclosure.

### DETAILED DESCRIPTION

A unit is disclosed for validating a communication network of an industrial automation and control system, as is a method of validating a communication network of an industrial automation and control system. For example, a unit is disclosed for validating a communication network of an industrial automation and control system, as is a method of validating a communication network of an industrial automation and control system, wherein it can be effectively validated that the communication network of the industrial automation and control system has been deployed to a high degree of correctness.

According to the present disclosure, a unit or tool can be provided for validating a communication network of an industrial automation and control system, which includes: a planner module configured to store plan or configuration data defining a designed communication network of an industrial automation and control system, a collector module configured to collect effective data defining or representing a deployed communication network of the industrial automation and control system, and a difference detector configured to detect or identify differences between the designed communication network and the deployed communication network using the plan data and the effective data. The validation unit may be included into existing commissioning tools for commissioning industrial automation and controls systems, for example into an testing tool used for engineering and commissioning of substation automation systems. For example, the validation unit may include programmed software modules comprising computer code for directing a processor of a computer to perform the required functions. Accordingly, a notebook or laptop computer including the validation unit may be plugged to one of the devices or components of the deployed communication network, for example to a switch, of the industrial automation and control system and validation of the deployed communication network may be performed by collecting effective data of the deployed communication network and comparing the effective data with plan data. Hence, a validation unit as disclosed herein can provide for automatic, reliable and fast validation of a deployed communication network, such that production delay, downtimes and security risks can be minimized.

In an exemplary embodiment, the collector module can be configured to collect the effective data by sending request messages to one or more network devices or network components of the deployed communication network of the industrial automation and control system. The request messages may be sent according to the plan data, which may include, for example, all network addresses of network components of the designed communication network. Hence, the collector module may, for example, send request messages to each of the network components.

The network components may be configured to send configuration messages in response to such request messages to the validation unit, wherein, for example, the configuration messages may include installed network connectivity indicative of physical and/or logical connections of the network components. Hence, the collector module may receive the configuration of network components of the deployed communication network and may generate effective data of the deployed communication network of the industrial automation and control system. In other words, a model may be built by communicating with all network components of the communication network using for example a standardized protocol, e.g. SNMP or IEC 61850 communication, which is supported by all network components and with which the network related information can be accessed.

The network communication model may be stored in a machine readable format as effective data, wherein all the physical connectivity, as well logical connectivity and all relevant network related configuration information are included. The logical connectivity may include VLAN (virtual local area network) filters, multicasting filters, etc. To obtain VLAN settings and multicast filters, each network component, for example each network switch or control, may be contacted to obtain the VLAN configuration settings of every port of the network component, for example from a Q-BRIDGE-MIB. MIBs (Management Information Base) are databases which include stored management information of managed devices. The database may have a tree-like structure, wherein each leaf is identified by a unique OID (Object Identifier). For instance, to get the VLAN identifier, by use of the SNMP protocol, the switch may be contacted to receive the value of the MIB object dot1qVlanIndex, which MIB object has the identifier 1.3.6.1.2.1.17.7.1.4.2.1.2.

In an exemplary embodiment, the collector module can be configured to detect and/or identify network devices, by broadcasting ping-type messages and evaluating the responses. For this purpose, the collector module may automatically choose and configure a network address which is not in use in the network by listening to LLDP packet from the switch to which it is connected to, by using the management address in the LLDP packet together with a known subnet mask of the network and by using ARP request to verify whether the chosen network address is not in use in the network. Such detection mechanism can be particularly helpful in case the deployed network components deviate in number and identification from those according to plan data.

Switches and controls of the deployed communication network of the industrial automation and control system may be configured to respond to the sender of a broadcast message with their network identity information, for instance their network address. Hence, the collector module may use the network identity information from the responses to the broadcast message for obtaining the configuration and for generating effective data of all components of the deployed communication network of the industrial automation and control system, by sending request messages as above. Furthermore the detection mechanism may be extended to sub networks of the network which are generally not reached by the broadcast detection messages mentioned. For this purpose, sub networks are identified from the management address entries in LLDP MIB of the border network devices.

In an exemplary embodiment, the collector module can be configured to collect the effective data using at least one of: Link Layer Discovery Protocol (LLDP), Simple Network Management Protocol (SNMP), an IEC 61850 data object, and an address forwarding table (AFT). These protocols and standards are widely available in known state-of-the-art network components. For example, LLDP is a vendor neutral protocol for advertising device identity and capabilities of network devices and facilitates the process of obtaining information about neighbouring devices; and SNMP is a protocol to query configuration data of network components.

End nodes, for example intelligent electronic devices (IED), laptops, printers, etc. may not have LLDP enabled. Thus, in order to map out the topology to the end nodes, address forwarding tables AFT may be inferred. For example, the AFT of a switch may include MAC addresses (MAC: Medium Access Control) along with port numbers through which packets destined for that address have to be forwarded.

In an exemplary embodiment, the difference detector is configured to build a comprehensive, or enhanced, network communication model of the designed communication network and a comprehensive network communication model of the effective communication network, wherein differences between the designed communication network and the deployed communication network are detected using the comprehensive network communication models. For example, the engineered respectively the designed communication network of an industrial automation and control system may be represented in the form of a machine readable system configuration. However, other expert/implicit information concerning the communication network may exist, which is not explicitly written in the configuration file, but which is applied when commissioning or deploying the communication network. Such expert/implicit information may indicate, for example, that ingress filters are turned off by default in all switches, that all switch ports not connected to end nodes are disabled, that a community string (a kind of pre-defined passphrase) is used to interrogate the switch using SNMPv2, or that the station computer can access all intelligent electronic devices (IED) of the communication network.

From such expert/implicit knowledge, a comprehensive communication model [C′] of the engineered/designed communication network can be built and stored in a machine readable format that includes all physical connectivity, logical connectivity (logical flow) and all relevant network related configuration information. Accordingly, a comprehensive network communication model [C] is determined from the deployed communication network. For example, the deployed network is only correct in case [C]==[C′].

In an exemplary embodiment, the difference detector can be configured to build a comprehensive network communication model of the deployed communication network and to transform the model into a system description file, wherein differences between the designed communication network and the deployed communication network are detected using this system description file. The comprehensive network communication model [C] of the deployed communication network may be built, as described herein, by collecting effective data of the deployed communication network. Thereafter, the model may be transformed to the system description file [S], which may be compared to the system description file [S′] of the engineered/designed communication network. The transformation may include a pattern matching, which can be seen as an expert knowledge corresponding to the expert knowledge described earlier. For example, the deployed network is only correct in case [S]==[S′]. For example, the comparison of information as described herein may include content comparison, string comparison, etc.

In another exemplary embodiment, the validation unit can include a notification module configured to generate one or more notification messages in case the difference detector detects one or more differences between the designed communication network and the deployed communication network. For example, the notification module may be configured to display differences between the designed communication network and the deployed communication network on a screen of a laptop computer. Alternatively, the notification module may be configured to transmit differences between the designed communication network and the deployed communication network to remote systems.

In addition to the unit for validating a communication network of an industrial automation and control system, a method is disclosed of validating a communication network of an industrial automation and control system, as is a computer program product which includes a computer-readable medium having stored thereon computer program code which directs a processor of a computer.

A method of validating a communication network of an industrial automation and control system, as disclosed herein, can include: storing plan data defining a designed communication network of an industrial automation and control system, collecting effective data defining a deployed communication network of the industrial automation and control system, and detecting differences between the designed communication network and the deployed communication network using the plan data and the effective data. In an exemplary variant, effective data can be collected by sending request messages to one or more network devices of the deployed communication network of the industrial automation and control system. In another exemplary variant, effective data can be collected using one or more response messages generated in response to one or more broadcast messages sent to the deployed communication network of the industrial automation and control system. In an exemplary variant, effective data can be collected using at least one of: Link Layer Discovery Protocol (LLDP), Simple Network Management Protocol (SNMP), an IEC 61850 data object, and an address forwarding table (AFT). In an exemplary variant, a comprehensive network communication model of the designed communication network and a comprehensive network communication model of the effective communication network can be built, wherein differences between the designed communication network and the deployed communication network are detected using the comprehensive network communication models. In an exemplary variant, a comprehensive network communication model of the deployed communication network can be built and transformed into a system description file, wherein differences between the designed communication network and the deployed communication network are detected using the system description file. In an exemplary variant, one or more notification messages can be generated in case the difference detector detects one or more differences between the designed communication network and the deployed communication network.

A computer program product as disclosed herein can include a computer-readable medium having stored thereon computer program code which will direct a processor of a computer to: store plan data of a designed communication network of an industrial automation and control system, collect effective data of a deployed communication network of the industrial automation and control system, and detect differences between the designed communication network and the deployed communication network using the plan data and the effective data.

FIG. 1 shows a validation unit 10 according to an exemplary embodiment disclosed herein. The validation unit 10 includes a planner module 11, a collector module 12, and a difference detector 13, and a notification module 14. For example, the validation unit 10 and/or the functional modules included in the validation unit 10 can be implemented as programmed software modules having computer program code for directing a processor of a computer to perform functions as described in the following. The computer program code can be stored on a tangible computer-readable medium which is connected in fixed or removable manner in the respective computer. Those skilled in the art will appreciate, however, that in alternative embodiments the functional modules may be implemented fully or at least partly by way of hardware components. The computer may include one or more network interfaces, for example in order to receive plan data of a designed communication network of an industrial automation and control system and for example to collect effective data of a deployed communication network of the industrial automation and control system. The computer may include a display which may be configured to display differences detected by the difference detector 13. Alternatively, a network interface of the computer may be configured to transmit differences detected by the difference detector 13 to one or more remote systems.

The planner module 11 is configured to store plan data of a designed communication network of an industrial automation and control system, which may include, for example, a planner file or a table according to Table 1 below.

The collector module 12 is configured to collect effective data of a deployed communication network of the industrial automation and control system, wherein, for example, the collected effective data may be arranged according to Table 2 below.

The difference detector 13 is configured to detect differences between the designed communication network and the deployed communication network using plan data and the deployed network configuration data, wherein, for example, the differences are marked with underline or strike-through attributes according to Table 2 below.

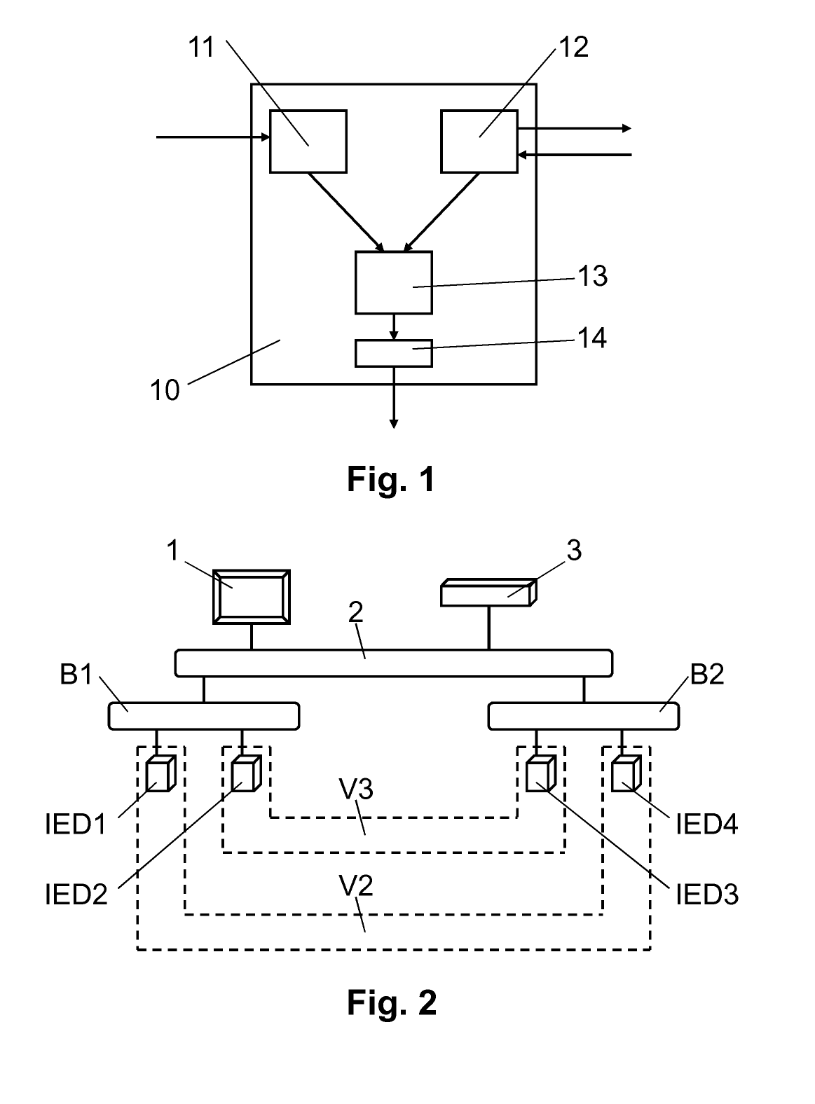

FIG. 2 shows schematically an exemplary designed communication network of a substation automation system requested by a customer. A station computer 1 is connected to a station bus 2. A gateway 3 is connected to the station bus 2 as well. Moreover, a first bay B1 and a second bay B2 are connected to the station bus 2. The first bay B1 serves for connecting a first intelligent electronic device IED1 and a second intelligent electronic device IED2. The second bay B2 serves for connecting a third intelligent electronic device IED3 and a fourth intelligent electronic device IED4.

FIG. 2 may relate, for example, to a communication network of a substation of an electric power system (e.g., in high and medium-voltage power networks), wherein the substation includes primary devices such as electrical cables, lines, bus bars, switches, power transformers and instrument transformers, which may be arranged in switch yards and/or bays. These primary devices are operated in an automated way through the communication network by the substation automation system, which may be controlled by the station computer 1, for example. The communication network may include secondary devices of the substation automation system, including intelligent electronic devices IED1, IED2, IED3, IED4, which are responsible for protection, control and monitoring of the primary devices. The communication network may further include a gateway 3 which may provide access, for example, between the substation and/or the substation automation system and remote sites.

As indicated in FIG. 2, the intelligent electronic devices IED1, IED2, IED3, IED4 may be connected through an Ethernet-based communication network, which includes the station bus 2 as well as the bays B1, B2, in order to exchange system-wide information, e.g. according to the IEC 61850 protocol, such as, for example, status updates of switches and breakers, interlocking information, breaker and switch commands, and/or information reports.

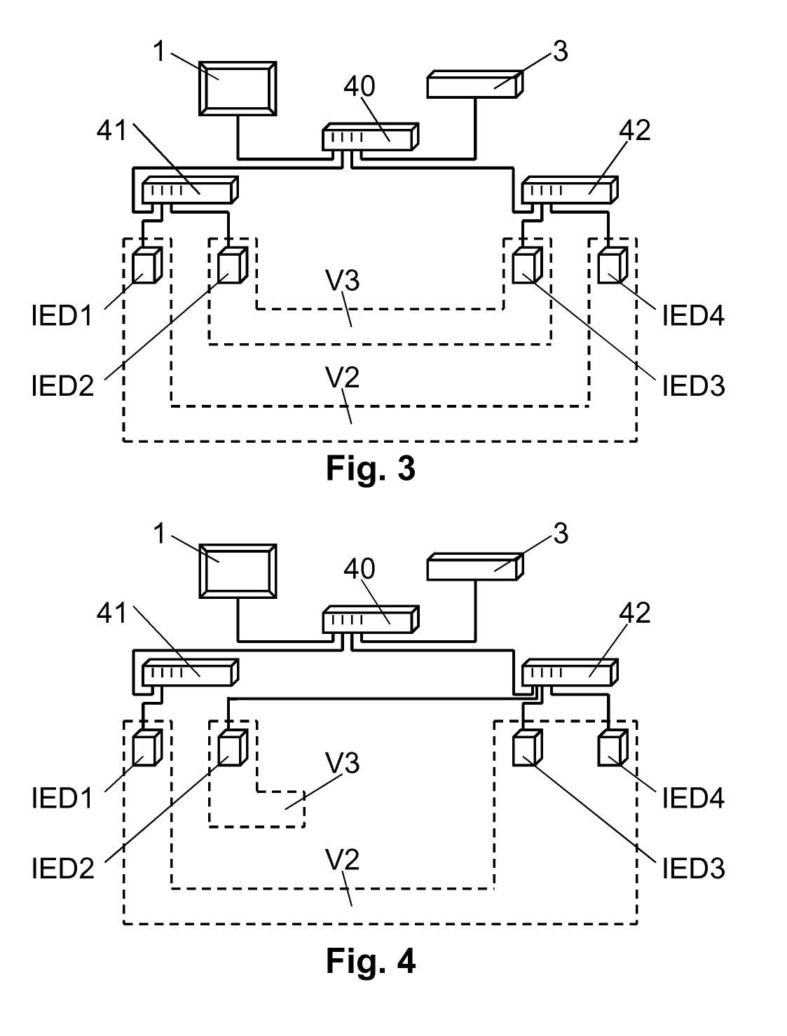

FIG. 3 shows schematically an exemplary designed communication network of a substation automation system which has been designed by an engineering team for designing industrial automation and control systems on the basis of the requested substation automation system according to FIG. 2. As shown in FIG. 3, a switch for the station level 40 is provided. Moreover, a switch for the first bay 41 and a switch for the second bay 42 are provided. The station computer 1 can be connected through a network cable to the switch for the station level 40, which is further connected through two network cables to the switch for the first bay 41 and to the switch for the second bay 42. The gateway 3 is connected through a network cable to the switch for the station level 40. The first and second intelligent electronic device IED1, IED2 are each connected through a network cable to the switch for the first bay 41. Analogously, the third and fourth intelligent electronic device IED3, IED4 can be each connected through a network cable to the switch for the second bay 42.

As indicated in FIG. 2, the first intelligent electronic device IED1 and the fourth intelligent electronic device IED4 can be arranged in a second VLAN (virtual local area network) V2. Similarly, the second intelligent electronic device IED2 and the third intelligent electronic device IED3 can be arranged in a third VLAN V3. Further VLANs, such as V4 and a management VLAN V1, may be desired or appropriate, but are not shown in FIG. 2 for sake of clearness. Accordingly, for example the first intelligent electronic device IED1 and the fourth intelligent electronic device IED4, which are both arranged within the second VLAN V2, form a group of hosts which may communicate as if they were attached to the same broadcast domain.

In FIG. 3, the intelligent electronic devices IED1, IED2, IED3, IED4 are arranged in a second VLAN V2 and in a third VLAN V3 as specified, which can be achieved, for example, through appropriate configuration of the switch for the first bay 41 and the switch for the second bay 42.

In Table 1, the data of the designed communication network is shown, which may be equal to or form the basis of the plan data.

TABLE 1

| | | | | | Physically |
|---|---|---|---|---|---|
| No. | Device name | IP address | VLAN | Communicate with | connected to |
| 1 | station | 192.168.10.10 | V4, | gateway 3, all | switch for |
| | computer 1 | | V1 | switches, IED1, | station level |
| | | | | IED2, IED3, IED4 | 40 |
| 2 | gateway 3 | 192.168.10.11 | V4, | station computer 1 | switch for |
| | | | V1 | | station level |
| | | | | | 40 |
| 3 | switch for | 192.168.10.12 | | Transports data only | station |
| | station level | | | | computer 1, |
| | 40 | | | | gateway 3, |
| | | | | | switch for first |
| | | | | | bay 41, switch |
| | | | | | for second bay |
| | | | | | 42 |
| 4 | switch for first | 192.168.10.13 | | Transports data only | switch for |
| | bay 41 | | | | station level |
| | | | | | 40, IED1 and |
| | | | | | IED2 |
| 5 | switch for | 192.168.10.14 | | Transports data only | switch for |
| | second bay 42 | | | | station level |
| | | | | | 40, IED3 and |
| | | | | | IED4 |
| 6 | IED1 | 192.168.10.15 | V2, | IED4, station | switch for first |
| | | | V1 | computer 1 (via V1) | bay 41 |
| 7 | IED2 | 192.168.10.16 | V3, | IED3, station | switch for first |
| | | | V1 | computer 1 (via V1) | bay 41 |
| 8 | IED3 | 192.168.10.17 | V3, | IED2, station | switch for |
| | | | V1 | computer 1 (via V1) | second bay 42 |
| 9 | IED4 | 192.168.10.18 | V2, | IED1, station | switch for |
| | | | V1 | computer 1 (via V1) | second bay 42 |

Based on to the information provided in Table 1, for example on the basis of corresponding plan data, commissioning engineers may deploy a network for a substation automation system.

FIG. 4 shows schematically the physical view of a deployed communication network for a substation automation system, which has been deployed by commissioning engineers according to the exemplary specifications set forth in Table 1 above. However, by mistake during commissioning the deployed communication network, the second intelligent electronic device IED2 is wrongly connected to the switch for the second bay 42. Moreover, the third VLAN V3 includes only the second intelligent electronic device IED2. The second VLAN V2 wrongly includes also the third intelligent electronic device IED3.

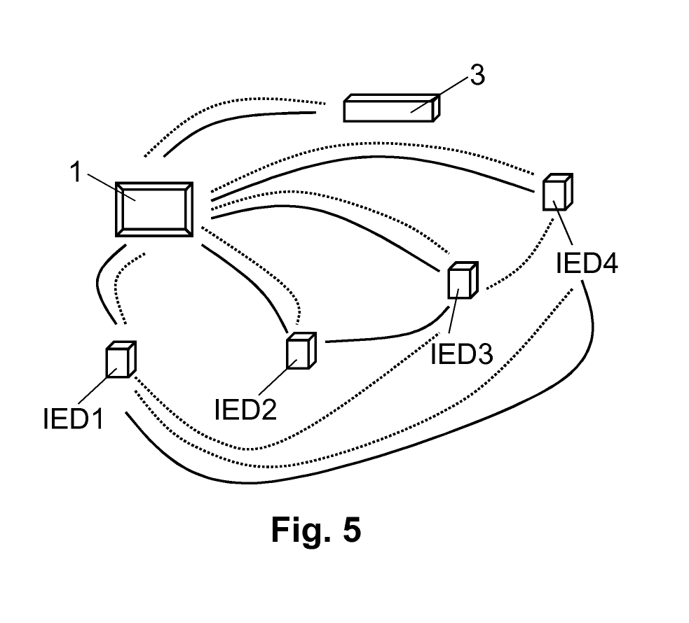

FIG. 5 shows schematically the logical view of the network according to FIG. 4, wherein the designed (specified) communication network is shown in solid lines and the designed (deployed) communication network is shown in dotted lines.

According to an exemplary embodiment, a collector module is configured to collect the effective data of the deployed communication network of the substation automation system. The collector module retrieves all the network related information (physical, logical, settings, etc.) from the deployed network. Upon receipt of this information, the network related information may be structured in a well-defined model, which is then compared to the designed model according to the designed communication network. For example, a method for validation or verification may include the step of whether every physical and logical network communication and whether every network control settings are similar or equal to what has been designed by the design engineers.

For example, the commissioned/deployed communication network may be modelled according to a tabulated model shown in Table 2:

TABLE 2

| | | | | Communicate with | Physically |
|---|---|---|---|---|---|
| No. | Device name | IP address | VLAN | or connect to | connected to |
| 1 | station | 192.168.10.10 | V4, | gateway 3, all | switch for |
| | computer 1 | | V1 | switches, IED1, | station level |
| | | | | IED2, IED3, IED4 | 40 |
| 2 | gateway 3 | 192.168.10.11 | V4, | station computer 1 | switch for |
| | | | V1 | | station level |
| | | | | | 40 |
| 3 | switch for | 192.168.10.12 | | Transport s data | station |
| | station level | | | only | computer 1, |
| | 40 | | | | gateway 3, |
| | | | | | switch for first |
| | | | | | bay 41, switch |
| | | | | | for second bay |
| | | | | | 42 |
| 4 | switch for first | 192.168.10.13 | | Transport s data | switch for |
| | bay 41 | | | only | station level |
| | | | | | 40, IED1 |
| 5 | switch for | 192.168.10.14 | | Transport s data | switch for |
| | second bay 42 | | | only | station level |
| | | | | | 40, IED2, |
| | | | | | IED3 and |
| | | | | | IED4 |
| 6 | IED1 | 192.168.10.15 | V2, | IED3, IED4, station | switch for first |
| | | | V1 | computer 1 (via V1) | bay 41 |
| 7 | IED2 | 192.168.10.16 | V3, | station computer 1 | switch for |
| | | | V1 | (via V1) | second bay 42 |
| 8 | IED3 | 192.168.10.17 | V2, | IED1, IED4, station | switch for |
| | | | V1 | computer 1 (via V1) | second bay 42 |
| 9 | IED4 | 192.168.10.18 | V2, | IED1, IED3, station | switch for |
| | | | V1 | computer 1 (via V1) | second bay 42 |

Accordingly a difference detector may be configured to detect differences between the data of Table 1, which corresponds to the designed network, and the data of Table 2, which corresponds to the deployed network. In Table 2 above, the errors which occurred during commissioning of the deployed communication network are marked by underlines, where additional communication network features were added, and by strike-through line, where desired communication network features are missing.

The validation unit 10 according to an exemplary embodiment disclosed herein can help the commissioning engineers in validating their deployed work against the engineered/designed network. When the deployed communication network is correctly validated, then confidence on the performance of the deployed communication network is increased. The validation helps the commissioning engineers in pinpointing the discrepancy between the deployed communication network and the designed communication network quickly. The ability to pinpoint the discrepancy may further be helpful in case of issues with a substation automation system, such that one can identify if a problem occurs due to a mistake in commissioning the communication network or due to another error source. In case of changes in the communication network or replacement of communication network components (cables, switches, etc.), the validation unit 10 can provide for fast and thorough testing.

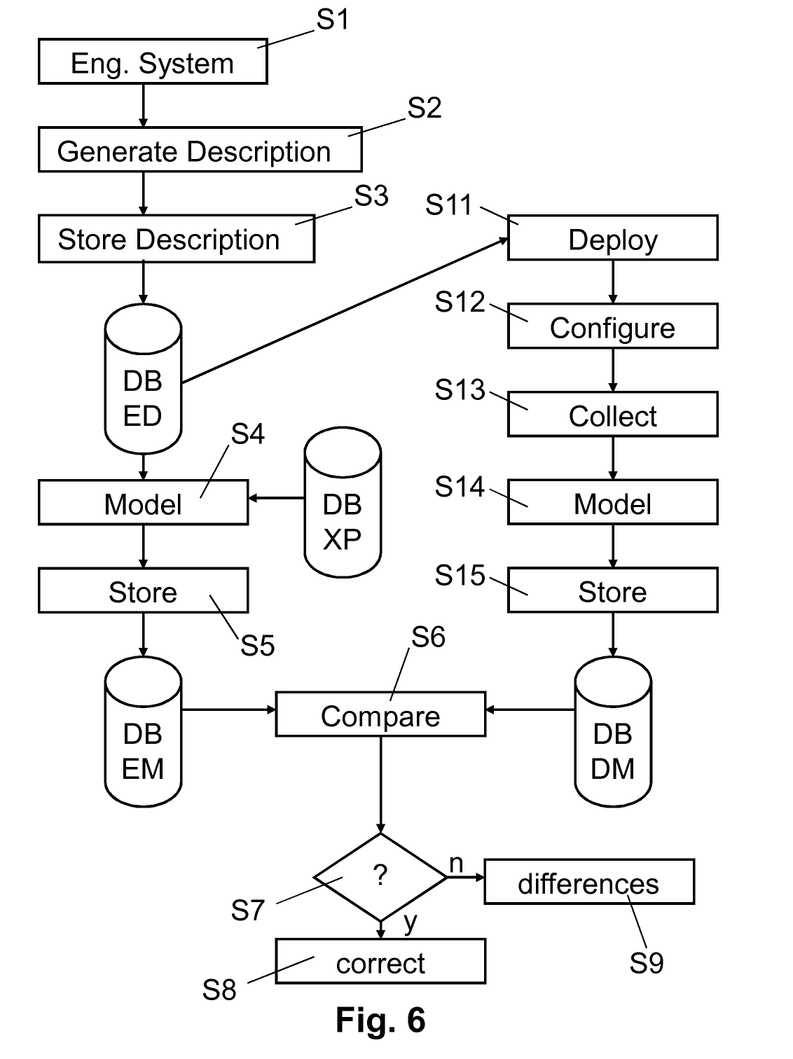

FIG. 6 shows schematically exemplary steps for validating a deployed communication network of the industrial automation and control system. In step S1, the design engineers design/engineer the specified industrial automation and control system according to a customer's specification. In step S2 a system description file is generated. In step S3, the system description file is stored in a database DBED. In step S4 a comprehensive network model of the designed/engineered communication network is built on the basis of the database DBED and a further database DBXP, which stores expert information. In step S5, the model of the designed/engineered communication network is stored in database DBEM. In step S11, commissioning engineers deploy a communication network of an industrial automation and control system.

In step S12, the deployed communication network is configured. In step S13, network related information is collected from the deployed communication network. In step S14, a comprehensive network model of the deployed communication network is built. In step S15, the comprehensive network model of the deployed communication network is stored in database DBDM.

In step S6, the comprehensive network model of the designed/engineered communication network from database DBED is compared to the comprehensive network model of the deployed communication network from database DBDM. In step S7, it is decided if a difference between the models can be detected. In step S8, when no difference between the models can be detected, for example a commissioning engineer is informed accordingly, for example by displaying a corresponding message on a screen of a computer that the deployed communication network does not have any errors. In step S9, when a difference between the models can be detected, the commissioning engineer may be informed about this fact by displaying a list with discrepancies between the designed communication network and the deployed communication network which are for example highlighted in order to maximize visibility of the faults in the deployed communication network.

Thus it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A unit for validating a communication network of an industrial automation and control system, comprising:
a planner module configured to store plan data defining a designed communication network of an industrial automation and control system;
a collector module configured to collect effective data defining a deployed communication network of the industrial automation and control system; and
a difference detector configured to detect differences between the designed communication network and the deployed communication network using the plan data and the effective data.

2. The unit according to claim 1, wherein the collector module is configured to collect the effective data by sending request messages to one or more network devices of the communication network of the industrial automation and control system, and to receive and process, in response, configuration messages including physical and/or logical connections of the network devices.

3. The unit according to claim 2, wherein the collector module is configured to collect the effective data via one or more response messages comprising:
network identity information of a responding network device and generated in response to one or more broadcast messages sent to the deployed communication network of the industrial automation and control system.

4. The unit according to claim 3, wherein the collector module is configured to collect the effective data via response messages comprising:
network identity information of responding network devices of identified sub-networks.

5. The unit according to claim 1, wherein the difference detector is configured to build, based on implicit or expert information, a comprehensive network communication model of the designed communication network, and is configured to detect differences between the designed communication network and the deployed communication network via the comprehensive network communication model.

6. The unit according to claim 5, wherein the implicit or expert information comprises at least one of:
i) ingress filters are turned off by default in all switches;
ii) all switch ports not connected to end nodes are disabled; and
iii) a station computer can access all intelligent electronic devices (IED) of the communication network.

7. The unit according to claim 1, wherein the difference detector is configured to transform, based on implicit or expert information, the effective data into a system description file of the deployed communication network, wherein differences between the designed communication network and the deployed communication network will be detected using the system description file of the deployed communication network and a system description file of the designed communication network.

8. The unit according to claim 7, wherein the industrial automation and control system is a substation automation system of a substation in a power transmission or distribution network, and wherein the system description files are substation configuration descriptions according to IEC 61850.

9. The unit according to claim 1, comprising:
a notification module configured to generate one or more notification messages in case the difference detector detects one or more differences between the designed communication network and the deployed communication network.

10. A method of validating a communication network of an industrial automation and control system, comprising:
storing plan data defining a designed communication network of an industrial automation and control system;
collecting effective data defining a deployed communication network of the industrial automation and control system; and
detecting differences between the designed communication network and the deployed communication network using the plan data and the effective data.

11. The method according to claim 10, wherein collecting effective data comprises:
sending request messages to one or more network devices of the deployed communication network of the industrial automation and control system; and
receiving, in response, configuration messages including physical and/or logical connections of the network devices.

12. The method according to claim 11, wherein collectively effective data comprises:
processing one or more response messages containing network identity information of a responding network device and generated in response to one or more broadcast messages sent to the deployed communication network of the industrial automation and control system.

13. The method according to claim 10, comprising:
building a comprehensive network communication model of the designed communication network based on implicit or expert information, wherein differences between the designed communication network and the deployed communication network are detected using the comprehensive network communication model.

14. The method according to claim 10, comprising:
building a comprehensive network communication model of the deployed communication network; and
transforming the comprehensive network communication model into a system description file, wherein differences between the designed communication network and the deployed communication network are detected using the system description file.

15. A computer program product comprising a non-transitory computer-readable medium having stored thereon computer program code which will, upon execution, direct a processor of a computer to:
store plan data of a designed communication network of an industrial automation and control system;
collect effective data of a deployed communication network of the industrial automation and control system; and
detect differences between the designed communication network and the deployed communication network using the plan data and the effective data.

16. The unit according to claim 4, wherein the difference detector is configured to build, based on implicit or expert information, a comprehensive network communication model of the designed communication network, wherein differences between the designed communication network and the deployed communication network will be detected using the comprehensive network communication model.

17. The unit according to claim 4, wherein the difference detector is configured to transform, based on implicit or expert information, the effective data into a system description file of the deployed communication network, wherein differences between the designed communication network and the deployed communication network will be detected using the system description file of the deployed communication network and a system description file of the designed communication network.

18. The unit according to claim 17, comprising:
a notification module configured to generate one or more notification messages in case the difference detector detects one or more differences between the designed communication network and the deployed communication network.

19. The method according to claim 12, comprising:
building a comprehensive network communication model of the designed communication network based on implicit or expert information, wherein differences between the designed communication network and the deployed communication network are detected using the comprehensive network communication model.

20. The method according to claim 19, comprising:
building a comprehensive network communication model of the deployed communication network; and
transforming the comprehensive network communication model into a system description file, wherein differences between the designed communication network and the deployed communication network are detected using the system description file.
